(19) United States
(12) Patent Application Publication
(10) Pub. No.: US 2020/0242576 A1
(43) Pub. Date: Jul. 30, 2020

(54) SYSTEMS AND METHODS FOR END-TO-END INTEGRATED PUBLICATION PLATFORM

(71) Applicant: Scriptdoor LLC, Carlsbad, CA (US)

(72) Inventor: Jamilyn Segal, Dubai (AE)

(21) Appl. No.: 16/652,673

(22) PCT Filed: Sep. 26, 2018
(86) PCT No.: PCT/US18/52866

§ 371 Date: Mar. 31, 2020

Related U.S. Application Data
(60) Provisional application No. 62/566,825, filed on Oct. 2, 2017.

(51) Int. Cl. G06Q 20/12; G06Q 10/10; G06Q 50/00; G06Q 40/00; G06Q 30/00; G06Q 30/02; G06F 16/951; G06F 16/958; H04L 29/06; G06N 20/00; G06K 7/14

(52) U.S. Cl. CPC G06Q 20/1235; G06Q 10/101; G06Q 50/01; G06Q 40/12; G06Q 30/0185; G06Q 30/0274; G06K 7/1417; G06F 16/951; G06F 16/958; H04L 63/105; H04L 63/0884; G06N 20/00; G06K 7/1413; G06Q 30/0277

(57) ABSTRACT

Disclosed are methods and systems for an end-to-end (writer-to-reader) integrated digital publication platform solution that allows for content creation individually or by collaboration, sharing, distributing, redistributing, purchasing, and social community surrounding readership. Users can create custom-made libraries and digitally stock their library with their own content or with purchased content or with free content available on the platform. Users can specify the level access other users may have to their libraries. Merchants can use the disclosed library system to provide digital publications to their patrons as a complementary part of their offerings or services.

### CROSS-REFERENCE TO RELATED APPLICATIONS

This application claims the benefit of priority of U.S. Provisional Application No. 62/566,825 filed on Oct. 2, 2017 entitled “System and Method for Integration of Online publishing, Formalized Social Media Platform and Paperless Waiting Areas,” content of which is incorporated herein by reference in its entirety and should be considered a part of this specification.

### BACKGROUND

This invention relates generally to methods and systems for software applications, and in particular an architecture enabling an end-to-end (writer-to-reader) integrated digital publishing platform.

### Description of the Related Art

Several gaps exist in today's fragmented publishing industry. For example, currently, users (business or individual) unfamiliar with the intricacies of the publishing industry cannot easily create their own publication and distribute them. Traditionally, writers would have to engage a publication agency to begin the long process of attracting a publisher and publishing their writings. Many useful and creative works of authorship have remained unpublished because of the difficult and uncertain processes of traditional publication industry. Recognition of brilliance and potential in a writing by virtue of well reception by a wide audience remains largely unrealized because currently, an online global publication platform, with users' ability to comment and share does not exist or only exists with limited or isolated integration. For example, existing platforms address integration in limited and isolated ways and often only directed to one or few aspects of the publication industry (e.g., platforms that focus only on books or platforms that only focus on magazines, or platforms run by publishing houses focused on their product and their consumers). Additionally, in other industries, such as recording and movie industries, talent and talented work have been recognized and developed more frequently and more efficiently by the introduction of online global video sharing platforms where users are able to comment and share. Unlike the content creators on video sharing platforms, the creators of written words, the writers largely have remained detached from their readers because the traditional publication industry lacks a global, integrated platform where writers can receive immediate feedback, connection and relationship from their readers.

Even savvy publishers are still isolated and their distribution channels are limited to print media and their online/digital utilization remains low. For example, publication owner emails a link to an e-publication, such as a digital publication, e.g., in Portable Document Format PDF form. The recipient opens the email and accesses the e-publication, but cannot conveniently make the publication available to its subscribers or customers, even with proper payments to and authorization from the publication owner.

The print publication industry, its models for creation, distribution and sharing of creative content, has not kept pace with the demands of modern times. Many functions within the life cycle of print content have remained unchanged from centuries ago and have not been updated. Paper is still the medium of choice and is used extensively throughout the world for distributing printed publications. Cafes, hotels, airports, train stations, office waiting rooms, or other similar businesses with physical establishments where patrons spend time, still use kiosks and generally print media to make publications available to their patrons.

Additionally, recycled publications past their shelf life have currently limited or no options for digital distribution, and they are under-utilized in current industry models. For many works of writing, print media remains the medium of choice for distribution. Many such publications have a shelf life past which, the current industry channels cannot utilize their value, and they are simply turned into paper waste, clutter or at best the knowledge embedded in them is hidden from readers and not used. Publishing industry paper waste is a substantial contributor to landfills. Businesses (e.g., hotels) which provide paper publications to a large customer-base (e.g., hotels providing magazines or newspapers to their guests) add substantially to paper waste in landfills and have a detrimental environmental effect.

Several of the industry issues and shortcomings will be addressed by systems and methods described herein.

### SUMMARY

In one aspect, an end-to-end integrated digital publication system is disclosed. The system includes: a subscription and access server configured to store a database of users, user profiles and user access credentials; a digital content database configured to store digital publication items, or access information on how to access digital publication items, or both; a library server, wherein the library server is configured to store one or more libraries associated with each user, wherein the one or more user libraries are capable of being accessed by other users and, wherein the one or more libraries comprise links to the digital content database based on a user's desired digital publication items.

In one embodiment, the system further includes a content creation server configured to provide digital publication tools, templates, guides and forms to users and users can create the digital publication items and store in the digital content database.

In another embodiment, the content creation server is further configured to allow a first user to invite one or more users to collaborate in content creation.

In some embodiments, a first user specifies a level of access by other users to the first user's one or more libraries and the level of access is stored in the subscription and access server.

In some embodiments, the system further includes a marketplace module, wherein digital publication items are uploaded for other users to download for a fee and the fee is specified by the user uploading the digital publication in the marketplace module.

In another embodiment, digital publication items are recycled print media (RPM).

In one embodiment, the system further includes a social media server enabling users to follow other users' activity.

In some embodiments, the system further includes a financial and accounting module configured to store financial transactions associated with each user.

In another embodiment, a first user grants access to a second user to read digital publication items in a library of the first user upon verification that the second user is a customer, client or patron of the first user.

In some embodiments, the verification comprises scanning a barcode or QR code from a receipt issued by the first user in possession of the second user.

In one embodiment, the system further includes an ad setup and management module and wherein a first user grants access to a second user to read digital publication items in a library of the first user and the ad setup and management module is configured to modify the digital publication items accessed by the second user with one or more advertisements, and wherein one or more advertising parameters associated with the advertisements are controlled by the first user, and advertising revenues are shared between the first user and an operator of the system, such that the majority of the advertising revenues are allocated to the first user.

In another embodiment, one or more of artificial intelligence, the second user's location, and profile data are used to generate the modified digital publication items.

In some embodiments, the one or more libraries include public and private libraries and public libraries are accessible to all users and private libraries are accessible to private groups determined by an owner of the private library.

In another aspect, a computer implemented method is disclosed. The method includes receiving, at a subscription and access server, a first user request to access a public library of a second user; sending, to a computing device of the first user, a request for credentials entitling the first user to access the public library of the second user; sending, to the subscription and access server, the credentials of the first user to access the public library of the second user; sending, to an authentication server, the credentials of the first user; validating the credentials of the first user and sending an approval message to the subscription and access server; sending access instructions to the first user to establish a connection between the first user and the public library of the second user hosted on a library server.

In one embodiment, sending the first user credentials to the subscription and access server includes scanning a barcode or a QR® code.

In another embodiment, the method further includes: receiving, at the subscription and access server, a request from the first user to access an item in the public library of the second user; sending, to the library server, a query to determine whether the requested item is available for access; upon determining availability of access, deducting a reservoir of available clicks for the requested item by one; allocating an access code and sending the allocated access code to the subscription and access server; associating, at the subscription and access server, the allocated access code with an identifier of the first user; sending the user-associated allocated access code to a computing device of the first user; receiving, at the library server, a request for content associated with the requested item along with user-associated allocated access code and returning the requested content to the first user.

In one embodiment, the method further includes modifying the content with one or more advertisements, and wherein one or more advertising parameters associated with the advertisements are controlled by the second user.

In another aspect, a non-transitory computer storage is disclosed. The storage stores executable program instructions that, when executed by one or more computing devices, configure the one or more computing devices to perform operations including: receive, at a subscription and access server, a first user request to access a public library of a second user; send, to a computing device of the first user, a request for credentials entitling the first user to access the public library of the second user; send, to the subscription and access server, the credentials of the first user to access the public library of the second user; send, to an authentication server, the credentials of the first user; validate the credentials of the first user and sending an approval message to the subscription and access server; send access instructions to the first user to establish a connection between the first user and the public library of the second user hosted on a library server.

In one embodiment, sending the first user credentials to the subscription and access server comprises scanning a barcode or a QR® code.

In another embodiment, the operations further include: receive, at the subscription and access server, a request from the first user to access an item in the public library of the second user; send, to the library server, a query to determine whether the requested item is available for access; upon determining availability of access, deduct a reservoir of available clicks for the requested item by one; allocate an access code and sending the allocated access code to the subscription and access server; associate, at the subscription and access server, the allocated access code with an identifier of the first user; send the user-associated allocated access code to a computing device of the first user; receive, at the library server, a request for content associated with the requested item along with user-associated allocated access code and return the requested content to the first user.

In some embodiments, paid publications in public libraries are viewable, but cannot be accessed unless one or more access codes are provided and paid publications can be purchased directly from the publisher of the paid publication or an approved distributor of the paid publication.

In some embodiments, the subscription and access server is further configured to provide automated access codes to users subscribing to a redistribution function within a business package to enable access to the RPM.

### BRIEF DESCRIPTION OF THE DRAWINGS

These drawings and the associated description herein are provided to illustrate specific embodiments of the invention and are not intended to be limiting.

FIG. 1 is a block diagram of an example system enabling users to connect to and use an integrated digital publication platform according to an embodiment.

FIG. 2 illustrates a block diagram of a library system which can be used in an integrated digital publication platform according to an embodiment.

FIG. 3 illustrates a block diagram of an integrated publication platform components according to an embodiment.

FIG. 4 illustrates an example component and data flow to establish a connection from a first user to a second user's library.

FIG. 5 illustrates an example messaging diagram which can enable a first user to access a library item within a public library of a second user.

FIG. 6 illustrates a messaging diagram which can enable advertising while fulfilling a first user's request for reading public/private library items of a second user.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

Definitions

When the terms “one”, “a” or “an” are used in the disclosure, they mean “at least one” or “one or more”, unless otherwise indicated.

Communication interfaces can communicate data using one or more wireless communication protocols such as Bluetooth, Bluetooth Low Energy (BLE), ZigBee, Wi-Fi, 802.11 protocols, Infrared (IR), Radio Frequency (RF), 2G, 3G, 4G, etc., and/or wired protocols and media. In some aspects and/or in some parts a communication interface can communicate via a communication platform, which may include one or a combination of the following: an Internet connection, such as a local area network (LAN), a wide area network (WAN), a fiber optic network, internet over power lines, a hard-wired connection (e.g., a bus), and the like, or any other kind of network connection. Communication platform may be implemented using any combination of routers, cables, modems, switches, fiber optics, wires, radio (e.g., microwave/RF links), and the like. Further, communication platform may be implemented using various wireless standards, such as Bluetooth®, BLE, Wi-Fi, 3GPP standards (e.g., 2G GSM/GPRS/EDGE, 3G UMTS/CDMA2000, or 4G LTE/LTE-U), etc. Upon reading the present disclosure, one of skill in the art will recognize other ways to implement communication platform for facilitating communications between the various parts of the described system.

The term “processor” can refer to various microprocessors, controllers, and/or hardware and software optimized for loading and executing software programming instructions or processors including graphical processing units (GPUs) optimized for handling high volume matrix data related to image processing.

The term “paid publications” can refer to media publications such as daily newspapers, monthly magazines, catalogs, books etc. bought by individuals for personal consumption or bought by corporations based on the number of user-clicks for the forecasted volume of their specific consumer-based consumption.

The term “free publication” can refer to media materials that are free for grab on the described platform, published by individual users or corporate publishers.

The term “grabs” can refer to free publications collected by users on the described publication platform to showcase in their respective public libraries. For example, a global coffee shop user can “grab” a children's book which has been published as “free publication” on the described publication platform. The children's book can be available from an author's original published material from his or her public library. The global coffee shop user can publish the children's book to its public library for its customers to view.

An Integrated Digital Publication Platform

The current deficiencies and shortcomings of the conventional publication industry can be addressed by an integrated digital publication platform (IDPP). Using the IDPP, publishers around the world can upload their publications in digital form, maintain control over product pricing, placement and distribution. The IDPP provides an integration of tools and environments which can be used by consumers, creators, viewers and motivators of the publishing industry. The IDPP can be used to efficiently organize, manage and distribute Recycled Print Media (RPM). RPMs are publications that are off the shelves for a variety of reasons, for example, out of date periodicals. The IDPP can be used to breathe new life to RPMs, for example by utilizing new markets such as the developing world, allowing RPMs to reach new untapped global viewers. Many RPMs are in paper form and are donated to or within the developing world in large containers and pallets. Recipients of these donations cannot efficiently use them because the donations often lack the organization and other data needed to distribute them properly. Often such donations add to clutter and end up as waste. The substantial sums spent on transporting pallets of RPM to the developing world are thus wasted. The IDPP can provide tools and organization to reduce or eliminate the waste associated with RPMs and repurpose them in an efficient way.

The IDPP also enables corporate publishers to repackage their advertising framework for their vintage publications and to create a new source of revenue with easy access to global distribution.

Additionally, the IDPP can be configured to enable individuals to create their own publications such as newspapers, and magazines for their own local community's news and events. The IDPP can also aspire these communities to create their own personal magazines, catalogs, albums or books by providing an integrated platform where the tools for content creation, collaboration, distribution and content consumption are easily available to them in one platform. The platform can give individuals freedom to create, collaborate and directly publish traditional print media publication and distribute to a private or global audience. In the case of an individual publisher, the IDPP can provide the individual with tools and a platform to attract a global audience. Individual publishers can attract a following for their creative work amongst their acquaintances, friends and colleagues and use common connections and referrals through the IDPP to build a global following.

In one embodiment, the IDPP provides user friendly, yet sophisticated content creation templates and guides in an integrated platform to enable individuals with limited publication experience to create content and distribute it. Independent publishers can formally publish electronic traditional media materials such as books, magazines and newspapers without the bottle neck of a publishing agency. In one embodiment, the IDPP includes a formalized social media module, which can be used to provide an integrated online community experience, where professional and amateur writers can collaborate.

In one embodiment, the IDPP includes a library module, where users are able to create public and private libraries and broadcast them to other users. Public libraries are libraries a user makes available to other users of the IDPP. Users can also define private libraries available to designated subscribers or personal groups. The public library functionality of the IDPP can enable individuals, organizations or corporations to create custom publications based on their target audience and direct their publications to consumers. A barcode system can be used to access these publications that are pre-paid by corporations as part of their added value service.

The IDPP can be used to create an online publishing, distribution and library platform that can be inclusive to many users around the world. Additionally, the system can be deployed as a global platform for sharing and buying publications across the world. The IDPP system can help a global user base write their stories, publish and distribute them.

The embodiments described herein can be used to integrate the functionality of multitude of global publication industry participants in an integrated (and in some embodiments, instant) digital publication platform. Individuals or corporations who were previously consumers of the publication industry can use the embodiments described herein to become creative producers as well as subscribers of a global publication industry. Using the described systems and methods the number of Print Media Content uploaded by the publishing companies can increase. Additionally, the described systems increase the user's ability to advertise on a global platform with control over placement, type, timing, target audience and other advertising factors as will be described. Additionally, advertisers can receive real-time reporting of their ad performance and reach and can modify their advertising strategy in real time. This allows an increase in the number of online advertisers and Corporation adapting to manage own advertising options. Publishers (corporate, business or individual) can also similarly receive real-time reporting of the performance of their products on the platform. The reporting can include metrics such as volume of sales, views and grabs and other relevant reporting metrics to allow publishers to assess performance of their products.

The embodiments described herein can increase the number of heavy consumer base corporations using the platform as part of their services. Additionally, online distributors can use the platform as part of their global distribution window. The described platform can provide an end-to-end publishing solution where publisher users can create, maintain and distribute their products in a cost-effective manner. Notably, implementing a publishing solution using the existing platforms can be cost-prohibitive for businesses with large customer-base and still not offer a comprehensive solution.

Some embodiments can be a marketplace and platform as service. They can be a cross breed between an online publishing and distribution, tailor-made library with social media functionalities. An inclusive online platform, users can create, sell, consume, collaborate and share a range of publications from variety of genres. Some embodiments are a publishing ecosystem integrating various publication industry functionalities. In some embodiments, three user categories can be publishers, individuals and corporations.

In some embodiment, the described publishing platform has a collaborative aspect, where users can invite and accept collaborators and work simultaneously on the same templates and be published in a formalized manner. The described system offers different kinds of templates from different genres of writing to users for content creation. Examples include books, newspaper, catalogs, magazines and albums. These templates can be accessed via Work In Progress Office Door (WIPOD), similar to a dashboard, for all types of users from novice to savvy. These functionalities will also enable users to formalize their personal social media content. WIPOD offers users high-end design tools and technology for all types of publications, so that users don't have to incur substantial expenses acquiring sophisticated software and hardware systems to be able to produce a professional-grade and high-end publication. WIPOD also levels the field between sophisticated and experienced publishers and inexperienced publishers, so they can both produce high quality publications, even if they have the cheapest tablet and the cheapest computer. Additionally, individuals, corporate publishers, influencers and/or businesses can earn income by virtue of other users subscribing to their public library collection. For Example, users are able to subscribe to the public liberty of a city and directly pay subscription fees to the city in order to access the city's public library available on the described platform. Transactions and internal algorithm are provided by the IDPP to enable users access to the public library of the city. Other transactions within the IDPP can include transactions between corporate publishers and businesses, where business can buy publications per user clicks basis from the corporate publishers, or create their own originals and grabs or a combination of the above in order to create a customized collection for the business. Income generating user accounts can be available to individuals, businesses, and/or corporate publishers in a cost-effective manner as part of their subscription with the IDPP. The public library collection of a publishing house can also be subscribed to by any user with a fee as specified by the corporate publisher.

The described systems and methods provide storage capacity to publishers to encourage them to upload current and recycled publications. The described systems and methods aim to host diverse publications to cater to different needs of global consumers. User accounts are equipped with a public library and private library functions for users to have options to share publications publicly or privately or to create group members. The public library of a user is the user's window to the world for publishers, individuals and corporations. Some functions of the public library are for a viewing mechanism for organized groups, e.g., book clubs, competition platform, corporate staff events, the use for corporations, such as hotels, train stations, airports, schools, etc. In one embodiment, the public library of a business user can be a platform for sharing selected publications with the business consumers as part of their value-added service. For example, hotels, train stations, airports, cafes and similar businesses with patrons who spend time at their business can share their public library to their patrons free of charge, as part of their other services or for a fee.

The described systems and methods include a feature for minors. Parents or guardians can create an account for a minor that allows the parents supervisory control of their ward's interactions on the described systems. For example, the user's publications, content access and time spent on content can be controlled and monitored. The parent can receive a report in real time, periodically or on demand.

The described systems and methods include servers and databases to implement user subscriptions to use the platform's functionalities and its benefits. An advertising and ad placement server enable business users to launch online advertising campaigns, with control over location placement (e.g., by geographical location of target audience from user profiles or from global positioning system GPS data), duration or other relevant advertising factors. Business users can also receive automatic, periodical or on-demand report of the result of their advertising campaigns and make changes real time or as they see fit. In other embodiments, advertising modifications can be automated with use of artificial intelligence AI, for example, based on a set of rules.

Users can also acquire additional storage. Upgraded subscriptions can also be implemented enabling premium features such as more storage, a no-ad experience, more professional templates or other features.

Several features of the IDPP that can address the deficiencies of the conventional publication industry will be described below.

Online Publication Marketplace and Publishing Platform as a Service

The described systems and methods include a collaborative website/application for current/recycled media materials globally. Licensed publishing companies, via their user account, can control their pricing, product placement, distribution, packaging and advertising. The described systems and methods provide accounting systems and statistical reports that can allow licensed publishing companies to have real time competitiveness, promote materials after their shelf life or after sell by date (e.g., vintage and expired publications). Publishing companies can upload RPMs and are able to manage their account on the website/application for financial or promotional benefit. Users, including publishing companies, can reach untapped global audience to view, read free or buy publications.

Reading materials can be provided in digital form to areas/distribution systems from private and public offices, clinics, firms, hotels, global food chains, transportation companies, schools, etc. Also, the described systems and methods enable small organizations to create their own libraries for their clients to read while waiting.

Individuals across the world can publish their writing in industry standard formats, such as in a form of a magazine, catalog, book, newspaper or album. Independent/individual publications can be published to public or private libraries, which can be controlled with user accounts. Automated templates and guides are provided online for easy and ready to use by individuals from beginners to professional writers.

Independent publishers can publish materials without the bottle neck of a publishing agency. On the other hand, to be able to attract the attention of a publishing agency through their followers or subscribers or directly endorse their publication to the publication agency of their choice through their user account. Reversed scouting cycle will become possible where individuals can be approached by publishers as their publications on their public library receive wide-spread approval and/or promise.

User-Created and User-Controlled Libraries

Users, including licensed publishers, businesses, corporations, organizations, non-governmental organizations (NGOs) and/or individuals, can create custom libraries as a window to share, sell or publish their written material to the public. For licensed publishers, a public library according to embodiments described herein can serve as the window to sell and showcase their publications. For individual users, a public library according to embodiments described herein can serve as the window to publications the individual grabbed for free or subscribed to, as well as their own created publications. For Corporations, a public library according to embodiments described herein can serve as a custom library designed for their consumers or patrons. Public library can include free publications, paid publications taken from the platform or own and/or community written content.

Public Library with Access Through a Unique Identifier

Using the described embodiments, publications can be seen by multiple consumer/audiences of the user without the need for physical printed media. Publications can be shared multiple times to other users, e.g., customers of a user. The IDPP enables businesses with a large customer-base (e.g., those in the hospitality industry, such as hotels) to personalize publication offerings (based on the business profile and/or their patrons' profiles). Publication materials can be chosen and/or be modified based on customer's profile. Additionally, the global reach of the IDPP allows publications to be globally accessible in a convenient manner. For example, a customer from New York, USA checking into a hotel in Africa can access and read publications from her home town using the hotel's IDPP account. Without the described embodiment, it may be cost-prohibitive for the hotel to provide such publications to its guests who may come from many diverse locals. Providing tailor-made publications to such a diverse customer-base can be difficult or cost-prohibitive without the IDPP embodiments described here.

Using the described embodiments, organizations can design custom libraries for their consumers to read and reduce the cost for producing and purchasing publications. As an example, using the described embodiments, a hotel user can purchase its daily newspapers in digital form through the described platform and share to the hotel guests. The hotel user can also create and personalize publications for its guests, for example by providing reading material relevant to the location visited or guests home countries.

The users who make their public library accessible to their patrons can pay for the items in their public library by various methods including per-click payment options, or lumpsum subscription fees paid directly to the publication owner and/or paid through the described platform.

As another example, a global coffee shop, using the described embodiments, can create its own public library or several public libraries (e.g., customized based on location). The public library can be viewed by its global consumers or regional consumers depending on the implementation and business or corporate goals of the user designing the public library.

Reverse Advertising

IDPP users can decide to enable advertising on their respective public libraries. IDPP makes available systems and methods for users to price and monitor advertising content. Advertisers can also apply to IDPP users to advertise on users' public libraries. In some embodiments, the IDPP can be designed to transfer a larger share of advertising revenues to content creator users. Current platforms, such as popular video sharing sites may allocate the larger share of advertising revenues to the platform operator. Such models can retard the creative process and discourage creative individuals to join the platform. IDPP can be configured to reverse this industry trend and allocate the majority of advertising revenues to the creators as opposed to platform operators. In this scenario, creative users are encouraged to continue adding high quality content to IDPP and other users within the platform.

Educational Institutions and Students

The described systems and methods can benefit schools and students in several ways. Educational institutions can acquire latest edition books in digital form for a lower cost and make available to their students as part of their public library. Individuals and corporations can conveniently donate publications, through gift options within the platform or can transfer a platform-specific currency/gift card option, such as a token to other users within the platform. School users can conveniently share news to student users or other school users across the world. Student users can be free of having to carry heavy, traditional paper books to schools/university. They can access their books in the platform's private or public libraries (their own library, their school's library, or their libraries on the platform) via one or more mobile computing devices, such as tablet computers. Traditional print media functionalities used by students such as highlighting sentences and adding notes can be enabled in student-accessed libraries and be provided electronically. Teacher and student users can conveniently access news, events and other publications in the same library for discussion, comments and education purposes. Additionally, collaboration will be facilitated when the described embodiments are used.

Work In Progress Office Door (WIPOD)

WIPOD is a dashboard in the described platform enabling the user to create publication using templates, guides and other tools to assist novice or professional writers to make high quality, interesting and professional-grade publication. WIPOD also enables collaboration between users to assist in creating professional-grade publication. For example, groups of users (e.g., students) are enabled to work in real-time on a template to create a publication. Additionally, students and/or teachers are able to formally view projects from other students or schools across the world for increased creativity and collaboration.

Reading Functionalities

The described embodiments can create a convenient and efficient reading platform for reading digital publications and can enable users to customize the reading experience based on their preferences. For example, in one embodiment, reading options which can be enabled include, flipping through digital pages, scrolling from side to side, scrolling from top to bottom, and study mode where highlighter, commenting and note taking tools are available.

Platform-Specific Tokens

In some embodiments, a platform-specific financial token can be deployed to normalize and streamline the transactions performed across the system. Users can exchange currency with platform-specific tokens. Tokens then can be used to pay for subscriptions, individual publication purchases, storage, upgrading libraries, gifting and advertising.

Use of a platform-specific token can simplify some global functionalities, accounting and reporting. For example, licensed publishers can assess financial success of a publication globally or regionally based on number of tokens gained from the sale of that publication on the platform. Whether or not tokens are used, users can have associated accounting systems, showing their financial activities on the platform.

Examples of Implementation, Architecture and Use of IDPP

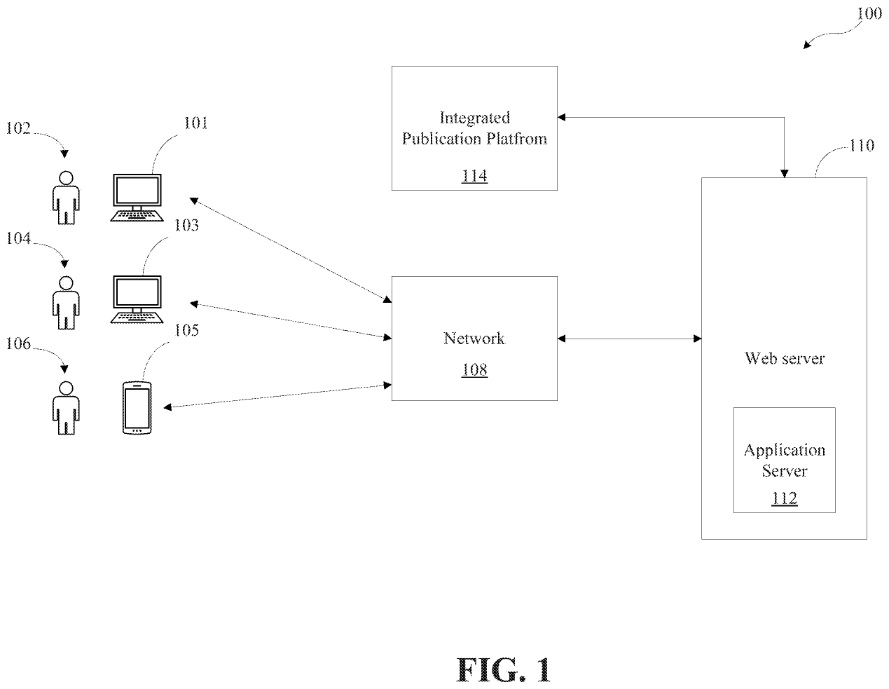

FIG. 1 is a block diagram of an example system 100 enabling users to connect to and use a digital publication platform according to an embodiment. Users 102, 104 and 106 can connect to a network 108 using computing devices 101, 103 and 105. Users can include participants, customers, consumers and/or creators of digital publication materials using the integrated publication platform 114. Users can be publishing houses, corporations, individuals or any organization interested in participating in a digital publication platform for education, profit and/or non-for-profit, community service or other purpose. The computing devices 101, 103 and 105 can include desktop computers, laptop computers, mobile computing devices such as smart phones and tablets and other similar devices. The configuration of computing devices 101, 103 and 105 can vary, but can include micro-processor circuit, short-term and long-term storage, input/output devices, such as keyboard, mouse, touchpad and display devices, etc. The computing devices 101, 103 and 105 can include communication interfaces enabling them to connect to the network 108 via wireless or wired connection. The network 108 can be a global network such as the internet.

Computing devices 101, 103 and 105 can run local and/or web-based client applications to connect to and use the services of the integrated publication platform 114. A web server 110 can serve clients residing and/or running on computing devices 101, 103 and 105 with the services and functionality provided by integrated publication platform 114. In some embodiments web server 110 can include one or more application servers 112. The web server 110 can further include one or more servers, subroutines, libraries and APIs for serving integrated publication platform 114 services to clients running or residing on computing devices 101, 103 and 105.

The integrated publication platform 114 can include modules, servers, subroutines, databases, communication protocols, layers and software programs to provide an end-to-end digital publication platform. For example, integrated publication platform 114 can provide content creation templates, user interfaces, digital publication, distribution, storage and library presentation (public/private), accounting, subscription, social media associated with users, their content, sharing and collaboration sub-platforms, advertising, reporting and metrics associated with published and/or on-sale content.

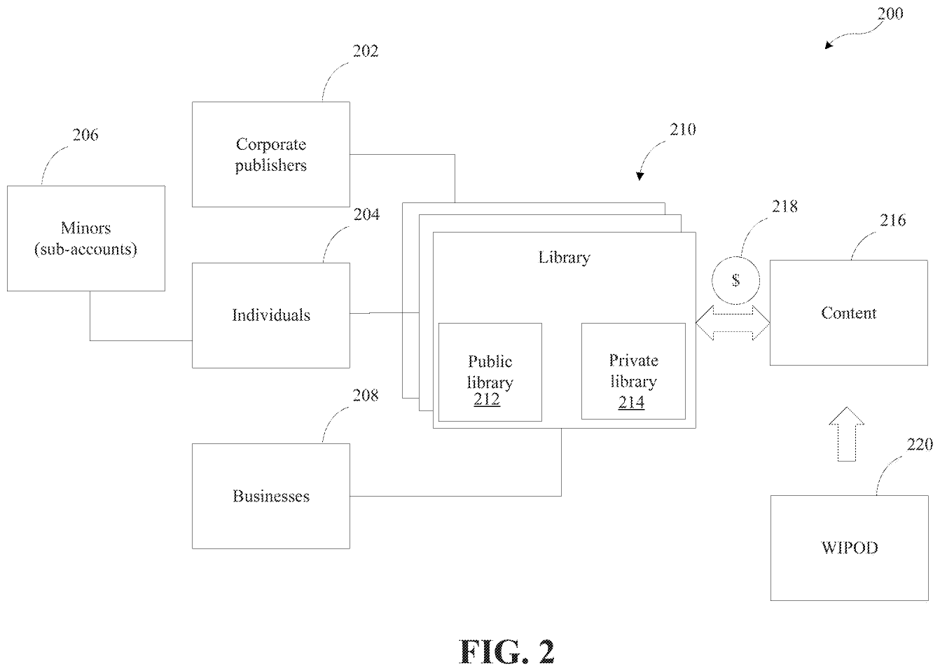

FIG. 2 illustrates a block diagram 200 of a library system which can be used in an integrated digital publication platform according to an embodiment. Users can include creators and consumers of digital publication content. The described integrated platform can assist users to both create digital publication and read works of others. Examples of users shown can include corporate publishers 202, individuals 204 and businesses 208. In some embodiments, minor users 206 can have sub accounts linked to their guardians or parents. Each user can have user-created and managed library 210, which can in turn have public library 212 and private library 214. Content 216 can be created and published in the library 210 using a creative dashboard 220. In some embodiments, the creative dashboard 220 is a collection of tools, templates, guides referred to as Work In Progress Office Door (WIPOD) that can assist and/or enable a user to create professional-grate digital publication content. The content 216 can also be purchased with general or platform-specific currency (e.g., tokens) 218.

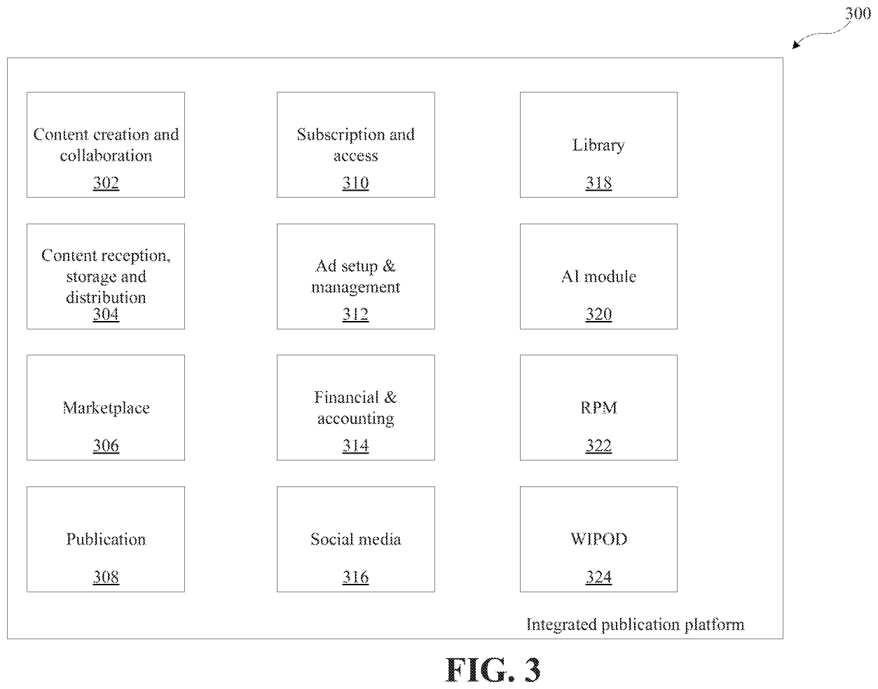

FIG. 3 illustrates a block diagram of an integrated publication platform 300 and its example components according to an embodiment. The platform 300 can include modules such as content creation and collaboration module 302, Content reception, storage and distribution module 304, marketplace module 306, publication module 308, subscription and access module 310, Ad setup and management 312, financial and accounting module 314, social media module 316, library module 318, artificial intelligence module 320, recycled print media (RPM) module 322, and work in progress office door 324. The modules and components illustrated are examples. More or fewer components can be used. In addition, modules need not be separate, and in some embodiments, modules can be combined or broken into other modules.

Content creation and collaboration module 302 is a platform for creating and collaborating to create digital content by individuals, corporations and/or publishers. The platform provides tools, editors and guides to create digital content. In some embodiments, the module includes predefined templates or can allow content creation by uploading PDF documents. Editors can collaborate with other editors to create content by collaborating as a team where content creator can invite individuals to create/edit content. Content can be shared, reviewed and receive feedback. Content owner has publishing authority, and can provide the same to another user.

Content reception, storage and distribution module 304 is a platform for distribution, receiving, storing and re-distribution of publishing material using a library system to showcase publications by the account owner or user. The libraries can can be accessed by and/or redistributed to followers and consumers.

Marketplace module 306 implements a global marketplace for publications such as periodicals, newspapers, books, magazines, menus leaflets and albums. In some embodiments, the module also can include tools for users to control the pricing, packaging, placement and associated promotions of their publications.

Publication module 308 can be used to implement a platform to conveniently publish digital content to public and private groups as a free, per download/click or subscription-based service. Also, in some embodiments the module can allow publishers/Individuals to group digital content for subscription.

Subscription and access module 310 can manage users' subscription and access within the integrated publication platform 300. The module can be used to enable users to subscribe and read digital content available within the system 300. Users can sign up, create a profile, build their library system and read the content available for public or can subscribe to private contents (e.g., with platform-specific tokens if used). Users can search for content by an author's name, category, genre, language, country, etc. Users can read content, rate, comment, like and share it with other users of the system 300.

Advertising setup and management module 312 includes tools for users to setup advertisements and/or advertisement campaigns that are displayed on individual digital content items or through displayed to other users when they access the advertiser's public library within the system 300. The module can run ads based on a variety of preset rules, including rules on timing, duration, geographical location, and other factors that might be of interest to an advertiser. In some embodiments, the module can interface with the artificial intelligence (AI) module to fine tune the preset rules and improve advertising effectiveness using statistical analysis or artificial intelligence techniques such as machine learning.

Financial and accounting module 314 can implement users accounting, financial reporting and other financial aspect of interest to users and administrators of the system 300. In some embodiments, a platform-specific token can be the medium of financial exchange and transactions within the system 300. Tokens can be used to carry out any transaction within the system 300. Tokens can be predefined denominations in U.S. dollars and the available payment method for users to subscribe to digital content or pay for other paid services within the system 300. Users can donate and/or transfer tokens to other users. Nontransferable tokens can also be made available for charity purposes. For example, tokens can be donated to schools in developing countries to build up their online library content for their student users. In some embodiments, blockchain technology can be used to maintain the security and integrity of the platform-specific token.

Social media module 316 can enable users of the system 300 to message other users, follow other user's activity within the system 300 and create a community approach to their reading and writing experience within the system 300.

Library module 318 can enable users of the system 300 to create custom (public and/or private) libraries based on the user's preferences. The user can acquire/purchase free or paid publications and display them in the user's public library. In some embodiments, the user can share access codes to the user subscribers within the system 300, so the user subscribers can access paid publication within the user's public library free of charge. As an example, a global coffee shop user can purchase Time® magazine and display Time® magazine in its public library accessible only to its customers. The global coffee shop can provide its customers with access codes to read Time® magazine or other paid publications. In some embodiments, users can purchase paid publication to make available to their subscribers/customers based on number of clicks, number of users granted access codes, or other arrangement.

The library module 318 can also enable users to create private libraries used for personalization of publication materials to specific consumers. This option can be used for example by a hotel user to make a custom private library available to its guests. Educational institutions can also create private libraries associated with each student class/grade. Users can edit and customize access levels to both their public and private libraries as they see fit. For example, a user may make its public library visible to any user within the system 300. Another user may choose to make its public library accessible to only the subscribers of the user. A business user can restrict access to its public library to only those users who are patronizing the business and only during such times. The library module 318 can enable other or similar customization of access to public or private libraries.

Artificial intelligence module 320 can assist other modules within the system 300 to implement automation, rules and rule finetuning based on training a set of rules on the user-base of the system 300 or other statistical or AI techniques. The module, in some embodiments can provide financial reports, user activity reports, statistics and real time responses/modification to various modules within the system 300. The module can also provide performance measures including the number of subscribers based on region, language, digital content category and revenue generated on any ads the user may be running, along with other performance parameters.

Recycled print media (RPM) module 322 aggregates, makes available and distributes access to recycled print media, out of date periodicals or other publications.

Work in progress office door (WIPOD) module 324 provides tools, guides and other features to assist users in creating professional-grade publication content to be distributed, shared, featured or otherwise made available on the system 300. For example, students can source educational materials and search for references through the marketplace module 306 or from the libraries of their respective educational institutions within the system 300. The WIPOD module 324 can enable students to study publications online through a study view option, create presentations, present their documents/projects through their account and publish their content to public or private libraries within the system 300 using acceptable publication industry formats.

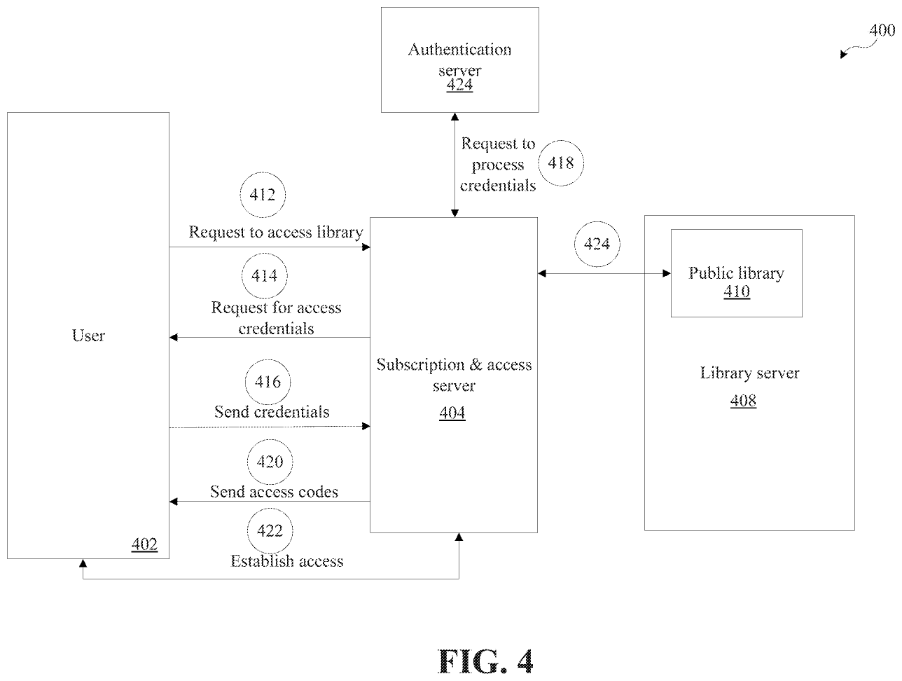

FIG. 4 illustrates example components and data flow 400 to establish a connection from a first user to a second user's library. The first user 402 sends a request 412 to subscription and access server 404. The request 412 can be a request to access a public library of a second user. The subscription and access server 404 sends a request 414 to the first user 402. The request 414 can be a request for access credentials of the first user. The first user 402 sends a response 416 to subscription and access server 404. The response 416 can include the credentials of the first user, which entitle her to access the public library of the second user. In one embodiment, the first user may be a customer of the second user, for example, a patron of a coffee shop. The second user can provide its customers with credentials to access its public library. In one embodiment, the credentials can include a unique identifier (e.g., a QR® code or barcode, printed on receipts provided to customers or other authentication methods). The second user can digitally stock its public library with publication of its own creation or other free or purchased publications available on the system 300 to provide to its customers.

The subscription and access server 404 receives the first user 402's credentials and sends a request 418 to an authentication server 424 for processing. The authentication server 424 processes the request and sends an approval or rejection response to the subscription and access server 404. In some embodiments, the authentication server 424 may be implemented as an internal component of the subscription and access server 404. If the user credentials are approved, the subscription and access server 404, sends a message 420 to the user 402. The message 420 can include instructions and data the user 402 can utilize to access the public library of the second user. Instructions and data can include access codes, IP address, Uniform Resource Locator (URL) and other data identifying location and access protocols, encryption keys, access codes, passwords, or other data the user 402 can utilize to access the second user's public library on the library server 408. The user 402 can send and receive messages, requests and responses to and from the library server 408 and public library 410 via messages 422 and 424.

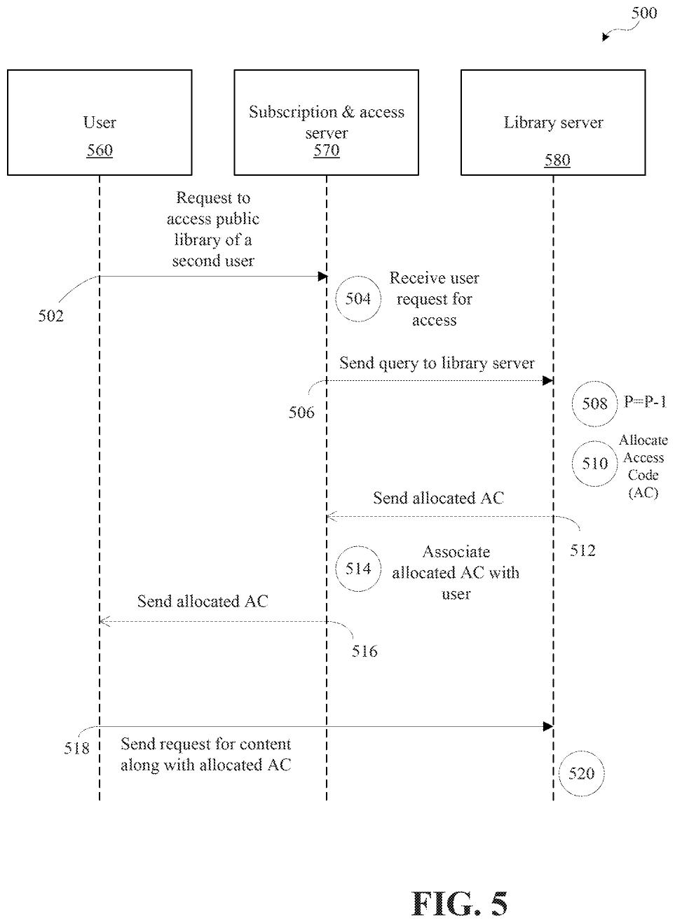

FIG. 5 illustrates an example messaging diagram 500 which can enable a first user 560 to access a library item within a public library of a second user. An initial connection between the first user and the second user's public library can be established via the embodiment of FIG. 4. The first user 560 browses the public library of the second user and sends a request 502 to subscription and access server 570 to access a library item within the public library of the second user. At step 504, the subscription and access server 570 receives the request 502 and sends a query 506 to the library server 580 to determine whether the requested library item exists, can be accessed and if yes start the process of granting access. The library server determines availability of the library item. In the case where the requested library item has been purchased by number of clicks, at the step 508, the library server 580 notes the click (e.g., by deducting a point from the reservoir number of clicks previously purchased by the user 2). In step 508, the library server 580 allocates an access code to the request. In step 512, the library server 580 sends the allocated access code to the subscription and access server 570. At the step 514, the subscription and access server 570 associates the allocated access code to the user 560. At the step 516, the subscription and access server 570 sends the allocated access code to the user 560. At the step 518, the user 560 sends a request to the library server 580 for content. The request 518 includes the allocated access code and other identifiers for library server 580 to approve and process the request. At the step 520, the library server 580, either fulfills the request 518 internally or routes with associated access codes to an external server for fulfillment.

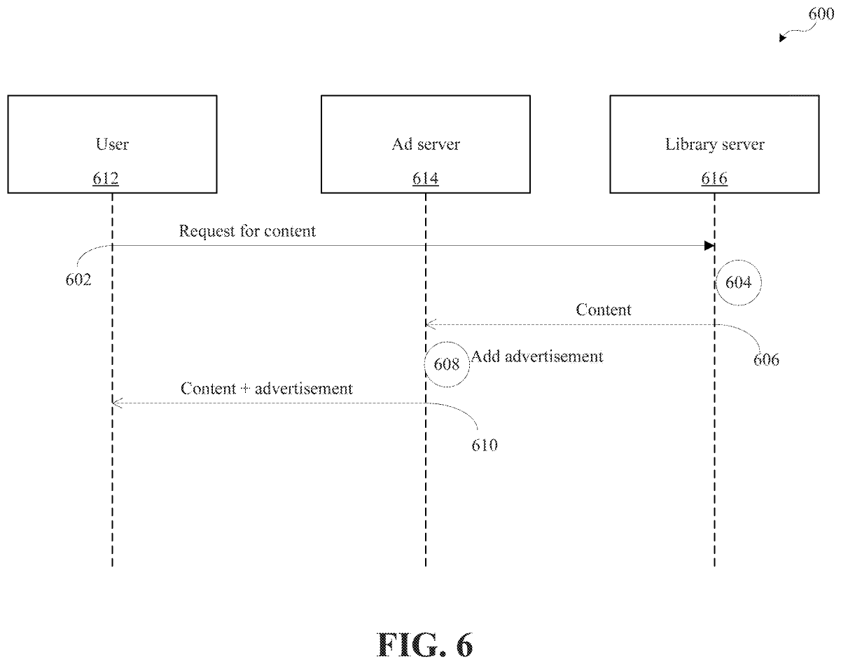

FIG. 6 illustrates a messaging diagram 600 which can enable advertising while fulfilling a first user's request for reading public/private library items of a second user. Initially, the connection between a first user and a public library item of a second user can be established via the embodiments of FIGS. 4 and 5. The first user 612 sends a request 612 to library server 616 to access content on a public library of a second user. At step 604, the library server 616 receives the request 602. At the step 606, the library server sends the requested content to an ad server 614. At the step 608, the ad server 614 adds advertisement to the content. The added advertisement can be static and previously determined by the second user or it can be dynamic and utilize AI to generate a relevant advertisement dynamically based on the first user's profile, location, or based on the second user's dynamic advertising parameters, such as limited time offers or other methods. The addition of advertising can be in the form of a modified user interface presented to the first user, or by dynamically modifying the requested content. For example, the ad server 614 can populate a preconfigured ad space on the requested content with a relevant ad chosen from a library of ads.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. An end-to-end integrated digital publication system comprising:
a subscription and access server configured to store a database of users, user profiles and user access credentials;
a digital content database configured to store digital publication items, or access information on how to access digital publication items, or both;
a library server, wherein the library server is configured to store one or more libraries associated with each user, wherein the one or more user libraries are capable of being accessed by other users and, wherein the one or more libraries comprise links to the digital content database based on a user's desired digital publication items.

2. The system of claim 1 further comprising a content creation server configured to provide digital publication tools, templates, guides and forms to users and users can create the digital publication items and store in the digital content database.

3. The system of claim 2, wherein the content creation server is further configured to allow a first user to invite one or more users to collaborate in content creation.

4. The system of claim 1, wherein a first user specifies a level of access by other users to the first user's one or more libraries and the level of access is stored in the subscription and access server.

5. The system of claim 1, further comprising a marketplace module, wherein digital publication items are uploaded for other users to download for a fee and the fee is specified by the user uploading the digital publication in the marketplace module.

6. The system of claim 5, wherein digital publication items are recycled print media (RPM).

7. The system of claim 1 further comprising a social media server enabling users to follow other users' activity.

8. The system of claim 1 further comprising a financial and accounting module configured to store financial transactions associated with each user.

9. The system of claim 1, wherein a first user grants access to a second user to read digital publication items in a library of the first user upon verification that the second user is a customer, client or patron of the first user.

10. The system of claim 9, wherein the verification comprises scanning a barcode or QR code from a receipt issued by the first user in possession of the second user.

11. The system of claim 1 further comprising an ad setup and management module and wherein a first user grants access to a second user to read digital publication items in a library of the first user and the ad setup and management module is configured to modify the digital publication items accessed by the second user with one or more advertisements, and wherein one or more advertising parameters associated with the advertisements are controlled by the first user, and advertising revenues are shared between the first user and an operator of the system, such that the majority of the advertising revenues are allocated to the first user.

12. The system of claim 11, wherein one or more of artificial intelligence, the second user's location, and profile data are used to generate the modified digital publication items.

13. The system of claim 1, wherein the one or more libraries comprise public and private libraries and public libraries are accessible to all users and private libraries are accessible to private groups determined by an owner of the private library.

14. A computer implemented method comprising;
receiving, at a subscription and access server, a first user request to access a public library of a second user;
sending, to a computing device of the first user, a request for credentials entitling the first user to access the public library of the second user;
sending, to the subscription and access server, the credentials of the first user to access the public library of the second user;
sending, to an authentication server, the credentials of the first user;
validating the credentials of the first user and sending an approval message to the subscription and access server;
sending access instructions to the first user to establish a connection between the first user and the public library of the second user hosted on a library server.

15. The method of claim 14, wherein sending the first user credentials to the subscription and access server comprises scanning a barcode or a QR® code.

16. The method of claim 14 further comprising:
receiving, at the subscription and access server, a request from the first user to access an item in the public library of the second user;
sending, to the library server, a query to determine whether the requested item is available for access;
upon determining availability of access, deducting a reservoir of available clicks for the requested item by one; allocating an access code and sending the allocated access code to the subscription and access server;
associating, at the subscription and access server, the allocated access code with an identifier of the first user;
sending the user-associated allocated access code to a computing device of the first user;
receiving, at the library server, a request for content associated with the requested item along with user-associated allocated access code and returning the requested content to the first user.

17. The method of claim 16 further comprising modifying the content with one or more advertisements, and wherein one or more advertising parameters associated with the advertisements are controlled by the second user.

18. Non-transitory computer storage that stores executable program instructions that, when executed by one or more computing devices, configure the one or more computing devices to perform operations comprising:
receive, at a subscription and access server, a first user request to access a public library of a second user;
send, to a computing device of the first user, a request for credentials entitling the first user to access the public library of the second user;
send, to the subscription and access server, the credentials of the first user to access the public library of the second user;
send, to an authentication server, the credentials of the first user;
validate the credentials of the first user and sending an approval message to the subscription and access server;
send access instructions to the first user to establish a connection between the first user and the public library of the second user hosted on a library server.

19. The storage of claim 18, wherein sending the first user credentials to the subscription and access server comprises scanning a barcode or a QR® code.

20. The storage of claim 18, further comprising:
receive, at the subscription and access server, a request from the first user to access an item in the public library of the second user;
send, to the library server, a query to determine whether the requested item is available for access;
upon determining availability of access, deduct a reservoir of available clicks for the requested item by one; allocate an access code and sending the allocated access code to the subscription and access server;
associate, at the subscription and access server, the allocated access code with an identifier of the first user;
send the user-associated allocated access code to a computing device of the first user;
receive, at the library server, a request for content associated with the requested item along with user-associated allocated access code and return the requested content to the first user.

21. The system of claim 13, wherein paid publications in public libraries are viewable, but cannot be accessed unless one or more access codes are provided and wherein paid publications can be purchased directly from the publisher of the paid publication or an approved distributor of the paid publication.

22. The system of claim 6, wherein the subscription and access server is further configured to provide automated access codes to users subscribing to a redistribution function within a business package to enable access to the RPM.
